(19) United States
(12) Patent Application Publication
(10) Pub. No.: US 2024/0258538 A1
(43) Pub. Date: Aug. 1, 2024

(54) REAR TRAILER DOCKING TYPE TRAILER FUEL CELL SYSTEM

(71) Applicants: SUNGSAN VCC CO., LTD., Ulsan (KR); CHANG RIM MOATZ Co., LTD., Hwaseong-si (KR)

(72) Inventor: Seung-Kwen PARK, Suwon-si (KR)

(73) Assignees: SUNGSAN VCC CO., LTD., Ulsan (KR); CHANG RIM MOATZ Co., LTD., Hwaseong-si (KR)

(21) Appl. No.: 18/533,902

(22) Filed: Dec. 8, 2023

(30) Foreign Application Priority Data
Jan. 26, 2023 (KR) 10-2023-0010100

(51) Int. Cl. H01M 8/04082

(52) U.S. Cl. CPC H01M 8/04201; B60L 50/70; H01M 2250/20

(57) ABSTRACT

The present invention aims to provide a rear trailer docking type trailer fuel cell system. The present invention is configured to comprise: a fuel cell package; a trailer for mounting the fuel cell package; and a trailer mounting unit for docking the trailer with the fuel cell package to a vehicle, and the fuel cell package comprises a hydrogen tank to be configured as a stand-alone system.

### CROSS REFERENCE TO RELATED APPLICATIONS

This application claims priority to Korean Patent Application No. 10-2023-0010100 filed Jan. 26, 2023, the entire disclosure of which is incorporated herein by reference,

### TECHNICAL FIELD

The present invention relates to a rear trailer docking type trailer fuel cell system. More specifically, the present invention relates to a trailer equipped with a fuel cell system capable of continuous output. More specifically, the present invention relates to a rear trailer docking type trailer fuel cell system in which a fuel cell system capable of stand-alone operation using hydrogen fuel to improve the daily charge range of an electric bus is mounted on a trailer and utilized to operate an electric bus which satisfies the average daily range of a large business bus without external charging.

### BACKGROUND ART

City buses are characterized by repeated trips on the same route with short intervals between each trip, and thus in fact, the daily trips are performed with batteries charged overnight.

The average daily range of city buses varies by route and region, but the average daily range of large business buses surveyed by the Korea Transportation Safety Authority is 216.6 km, 240.2 km in Seoul, with a range of around 200 km.

The daily charge range of the currently released 200 kWh electric buses is evaluated to be within 150 km, and thus it is expected that difficulties will occur in deploying them on long-distance routes. Also, since the daily charge range is similar to the length of the route, a full charge is required every day, and it is highly likely that the range would be adversely affected by the decline in battery performance.

The driving segments that contribute to the degradation of vehicle fuel cell performance are load fluctuations, start/stop, high power operation, and idling, in this order.

For the existing fuel cell technology for buses and trucks, Elringklinger has developed NM5 40 kW stack module and applied Giantleap project to increase fuel cell system efficiency by reducing pressure losses on the cathode side of the fuel cell.

Fuel tank technology is a device for storing high-pressure charged hydrogen, which must pass 25 international standards and tests, including rupture, internal pressure, airtightness, explosion-proof, flame, impact tests, etc.

To improve the uptime and durability of fuel cell vehicles, it is necessary to optimize control and improve efficiency from a system perspective.

### PRIOR ART REFERENCE

### Patent Document

(Patent document 0001) Korean Utility Model Registration No. 20-0484860 (registered on Oct. 26, 2017)
(Patent document 0002) Korean Utility Model Laid-Open No. 20-2007-0000876 (laid open on Aug. 6, 2007)
(Patent document 0003) Korean Utility Model Registration No. 20-0475188 (registered on Nov. 5, 2014)

### DETAILED DESCRIPTION OF INVENTION

### Technical Task

It is a main object of the present invention to provide a modular fuel cell system capable of independent operation in a trailer docking type for extending the range of low-speed (urban or special section) electric buses.

It is another object of the present invention to provide a modular fuel cell system capable of independent operation in a trailer docking type for extending the range of low-speed (urban or specialized) electric buses, comprising a front door, a side door, a rear door, and a roof door to facilitate repair and replacement of parts.

### MEANS FOR SOLVING TECHNICAL TASK

The present invention aims at developing a layout for operating a fuel cell system, a trailer structure capable of mounting the developed fuel cell system, and a trailer capable of driving in connection with an electric bus (which can reduce the cost of the trailer system by using ready-made parts, and develop new parts).

According to the present invention, a rear trailer docking type trailer fuel cell system, comprising: a fuel cell package; a trailer for mounting the fuel cell package; and a trailer mounting unit for docking the trailer with the fuel cell package to a vehicle, is provided.

The fuel cell package is characterized in that it comprises a hydrogen tank to be configured as a stand-alone system.

The trailer is capable of independent operation in a trailer docking type, and provides a module fuel cell system comprising a front door, a side door, a rear door, and a roof door to facilitate repair and replacement of parts.

### Effect of Invention

The rear trailer docking type trailer fuel cell system of the present invention is developed as a range-extending trailer fuel cell system, is developed as a trailer fuel cell system capable of extending the range and operability through minimal modification of a general electric bus, and is developed as a fuel cell system capable of stand-alone operation, and comprises a hydrogen tank to be configured as a stand-alone system, thereby being applicable to various fields such as various mobility fields and emergency power generation systems.

In addition, the present invention has the effect of improving the operation rate of electric buses by developing a range-extending trailer fuel cell system.

In addition, the present invention is utilized as a mobile power generation system. The developed trailer fuel cell system may be towed by a vehicle and may be operated as a mobile power generation system capable of supplying AC power to the outside with minimal modification, and may be utilized for purposes that require external power supply, such as construction sites that require power supply and operation of welfare vehicles.

The present invention secures fuel cell system development technologies such as hydrogen fuel cell system control technology and packaging technology to develop a fuel cell system capable of stand-alone operation, thereby securing scalability to various fields.

In addition, policies to supply the use of electric buses and hydrogen electric buses are being promoted for eco-friendliness of large commercial vehicles with high emission rates, and the technology developed in this project may contribute to the expansion of the operation rate of electric buses and the development of hydrogen electric buses, thereby reducing the emission through eco-friendliness of large commercial vehicles.

### BRIEF DESCRIPTION OF DRAWINGS

FIG. 1 is a view schematically illustrating the structure of a rear trailer docking type trailer fuel cell system according to the present invention;

FIG. 2 is a view illustrating a schematic concept of an embodiment of a trailer, which is a main part of the present invention;

FIG. 3 is a view illustrating a concept of installing a bus rear body tow beam in the present invention;

FIG. 4 is a view illustrating the appearance of the trailer body, which is a main part of the present invention;

FIG. 5 is a conceptual view illustrating an optimal control concept for improving the energy consumption efficiency in the present invention;

FIG. 6 is a view illustrating a power distribution unit circuit and design concept; a of FIG. 7 is a side view of a trailer according to another preferred embodiment of the present invention;

b of FIG. 7 is a rear view of a trailer according to another preferred embodiment of the present invention;

a of FIG. 8 is an interior view of a trailer according to another preferred embodiment of the present invention;

b of FIG. 8 is a working state view of a front door of a trailer according to another preferred embodiment of the present invention;

c of FIG. 8 is a working state view of a roof door, side door and rear door of a trailer according to another preferred embodiment of the present invention;

FIG. 9 is a connection state view of a bus and a trailer according to another preferred embodiment of the present invention; and

FIG. 10 is an installation state view and a structure view of a safety shield according to another preferred embodiment of the present invention.

### BEST MODE FOR CARRYING OUT THE INVENTION

Hereinafter, preferred embodiments of the present invention will be described in detail with reference to the accompanying drawings. The objects, features and advantages of the present invention will be more readily understood by reference to the accompanying drawings and the following detailed description. In the drawings, like reference numerals are used to refer to like elements. In addition, in describing the present invention, where it is deemed that a detailed description of the relevant known components or features would obscure the gist of the invention, the detailed description is omitted.

In addition, terms such as first, second, A, B, (a), (b), and the like may be used to describe components of the present invention. Such terms are intended only to distinguish one component from another, and the nature, sequence, or order of such components is not limited by such terms. Where a component is described as being “connected,” “coupled,” or “attached” to another component, it is to be understood that the component may be directly connected or attached to the other component, but that another component may be “connected,” “coupled,” or “attached” between each component.

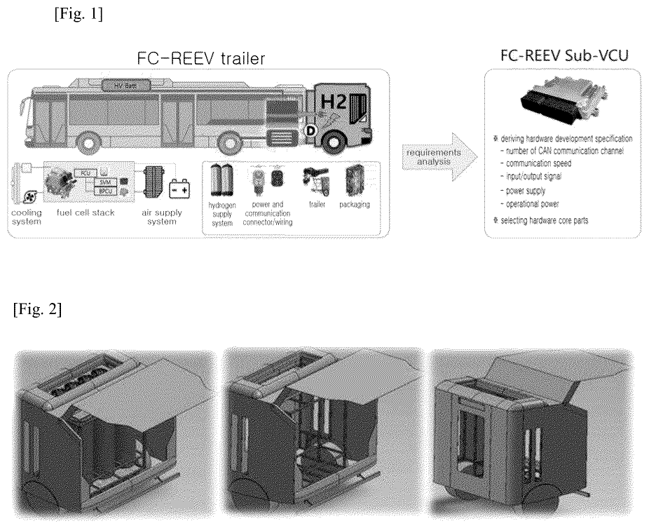

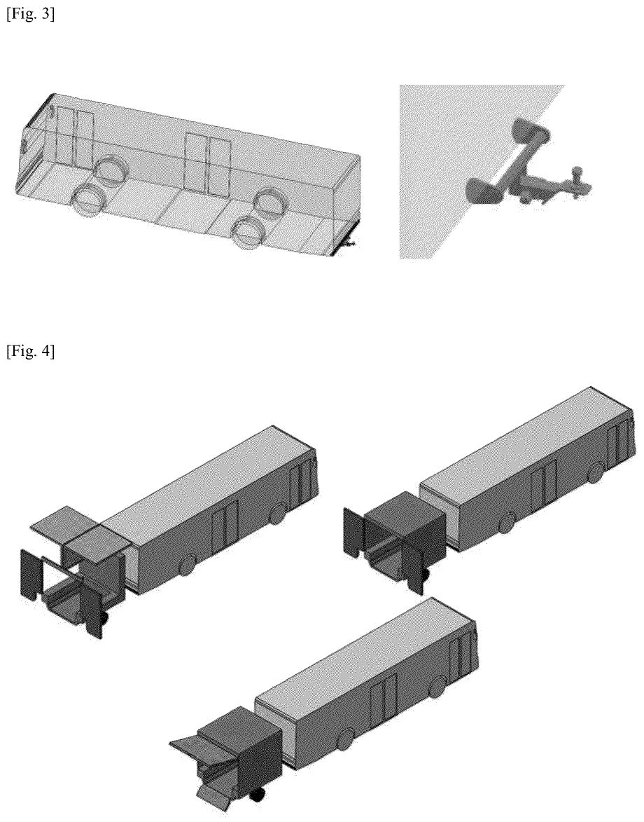

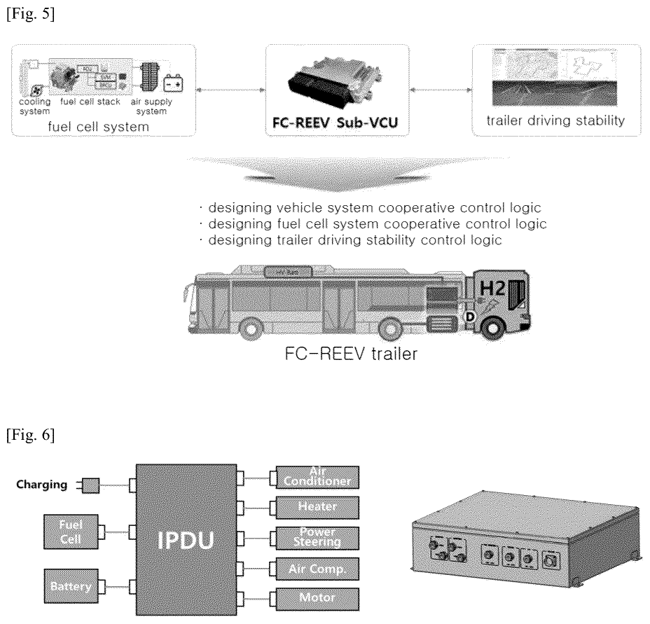

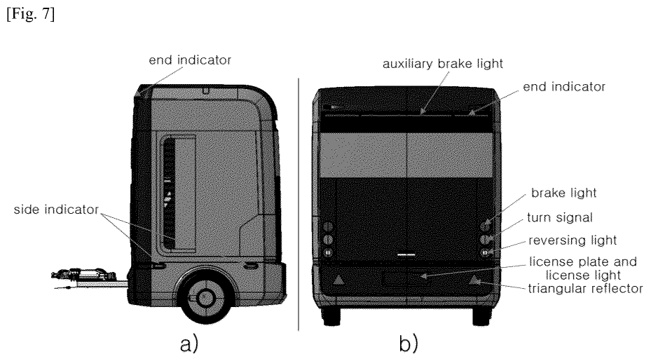

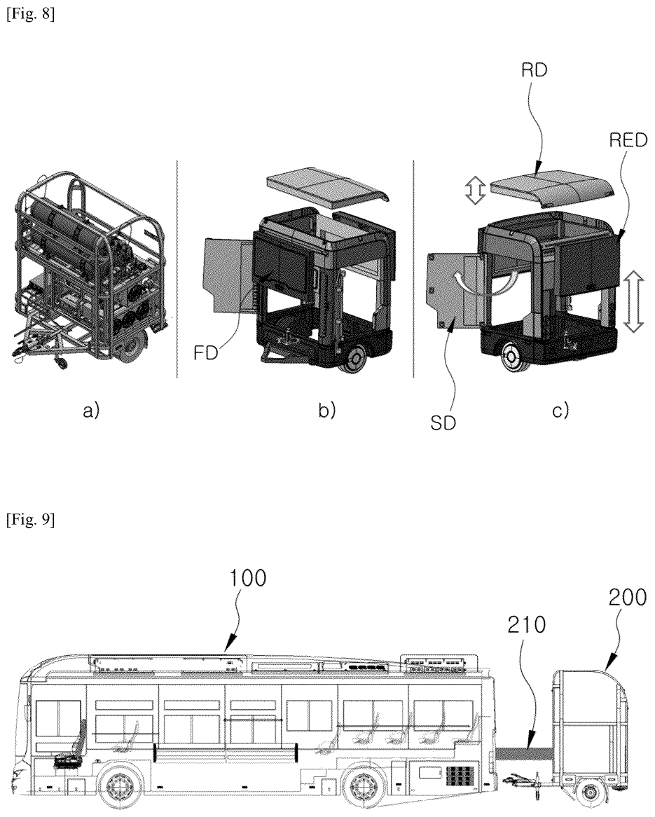

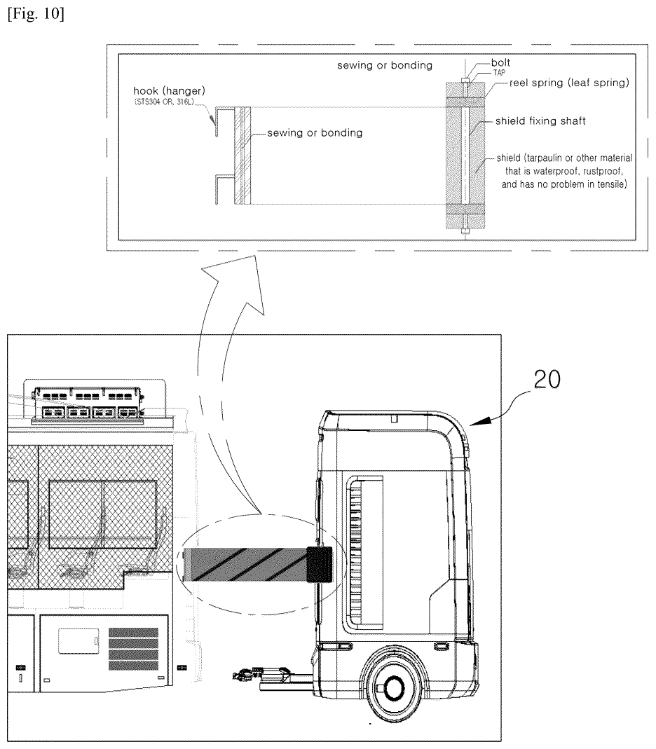

FIG. 1 is a view schematically illustrating the structure of a rear trailer docking type trailer fuel cell system according to the present invention. FIG. 2 is a view illustrating a schematic concept of an embodiment of a trailer, which is a main part of the present invention. FIG. 3 is a view illustrating a concept of installing a bus rear body tow beam in the present invention. FIG. 4 is a view illustrating the appearance of the trailer body, which is a main part of the present invention. FIG. 5 is a conceptual view illustrating an optimal control concept for improving the energy consumption efficiency in the present invention. FIG. 6 is a view illustrating a power distribution unit circuit and design concept. a of FIG. 7 is a side view of a trailer according to another preferred embodiment of the present invention. b of FIG. 7 is a rear view of a trailer according to another preferred embodiment of the present invention. a of FIG. 8 is an interior view of a trailer according to another preferred embodiment of the present invention. b of FIG. 8 is a working state view of a front door of a trailer according to another preferred embodiment of the present invention. c of FIG. 8 is a working state view of a roof door, side door and rear door of a trailer according to another preferred embodiment of the present invention. FIG. 9 is a connection state view of a bus and a trailer according to another preferred embodiment of the present invention. FIG. 10 is an installation state view and a structure view of a safety shield according to another preferred embodiment of the present invention.

The present invention aims at developing a layout for operating a fuel cell system, a trailer structure capable of mounting the developed fuel cell system, and a trailer capable of driving in connection with an electric bus (which can reduce the cost of the trailer system by using ready-made parts, and develop new parts).

The present invention is a rear trailer docking type trailer fuel cell system, comprising: a fuel cell package; a trailer for mounting the fuel cell package; and a trailer mounting unit for docking the trailer with the fuel cell package to a vehicle.

Also, in the present invention, the fuel cell package comprises a hydrogen tank to be configured as a stand-alone system.

The present invention consists of technologies for application and demonstration of 1) a modular fuel cell system capable of independent operation in a rear trailer docking type with a power generation output of 60 kW or more for continuous operation (5 minutes or more) and 2) a trailer modular fuel cell system vehicle (FC-REEV electric bus) to improve the durability and efficiency of fuel cell systems for commercial vehicles and extend the range of low-speed (urban/special section) electric buses.

The present invention is a trailer docking type modular fuel cell system technology. The present invention is a stand-alone modular fuel cell system, and embodies the development of a fuel cell durability analysis and life prediction algorithm, and the development of a modular fuel cell evaluation/verification system.

The present invention is a trailer modular fuel cell system vehicle application and demonstration technology, which embodies the development of an optimal control system for improving fuel cell endurance and efficiency, the technology for the application and demonstration of a trailer modular fuel cell system and vehicle, and the development of a business model.

The core technology of the present invention is the application and demonstration of a modular fuel cell system and vehicle (FC-REEV electric bus) capable of independent operation in a rear trailer docking type with a power generation output of 60 kW or more for continuous operation (5 minutes or more) to extend the range of an electric bus for rapid driving (urban or special section).

The present invention designs an FC-REEV Sub-VCU control algorithm concept, develops a CAN communication protocol for cooperative control between electric bus vehicles and fuel cell systems, acquires and analyzes real-world data for acquiring vehicle information such as APS, BPS, and battery SOC, and defines and documents a CAN communication protocol between electric bus vehicles and fuel cell systems.

The present invention embodies an FC-REEV integrated power distribution unit concept design. In other words, the present invention is developed as an integrated power distribution unit.

The safety shield in FIG. 10 utilizes a reel spring (leaf spring) to visually communicate to the public that a tow vehicle is connected to the passenger vehicle when the vehicle is traveling and parked. The safety shield is exposed to the outside, and thus is made of rustproof and vandal-resistant materials. The safety shield has a pull and hook configuration that may be easily attached and detached by the user, which ensures that the shield tension always maintains its shape after being engaged with the vehicle, so that the safety shield serves to inform that the tow vehicle and the passenger vehicle are connected.

Therefore, the present invention also has the effect of improving the operation rate of electric buses through the development of a range-extending trailer fuel cell system. Since domestic city buses are parked in public garages and operated, when expanding the supply of electric buses, the operation rate of electric buses is reduced due to the lack of charging infrastructure. However, by utilizing a trailer fuel cell system capable of stand-alone operation to extend the driving range, it is possible to operate an electric bus without external charging, thereby supporting the expansion of eco-friendly vehicles by improving the operation rate of electric buses.

In addition, the present invention is utilized as a mobile power generation system. The developed trailer fuel cell system may be towed by a vehicle and may be operated as a mobile power generation system capable of supplying AC power to the outside with minimal modification, and may be utilized for purposes that require external power supply, such as construction sites that require power supply and operation of welfare vehicles.

The present invention secures fuel cell system development technologies such as hydrogen fuel cell system control technology and packaging technology to develop a fuel cell system capable of stand-alone operation, thereby securing scalability to various fields. In addition, the expansion of electric buses to hydrogen electric buses with extended range is expected to increase the operation rate of electric buses and expand the hydrogen electric bus market, which is expected to improve the national status by generating corporate profits, defending the domestic market and expanding global market share based on localization of developed systems and vehicles.

In addition, policies to supply the use of electric buses and hydrogen electric buses are being promoted for eco-friendliness of large commercial vehicles with high emission rates, and the technology developed in this project may contribute to the expansion of the operation rate of electric buses and the development of hydrogen electric buses, thereby reducing the emission through eco-friendliness of large commercial vehicles.

As used herein, the terms “comprise,” “consist of” or have” mean that the component may be inherent, unless specifically stated to the contrary, and thus it should not be interpreted as excluding other components, but rather as allowing for further inclusion of other components. Unless defined to the contrary, all terms including technical or scientific terms used herein have the same meanings as those generally understood by a person having ordinary skill in the art. The terms defined in the dictionary which are generally used should be interpreted to have the same meaning as the meaning of relevant technology in context. Additionally, unless the present invention clearly defines, the terms are not interpreted idealistically or excessively formally.

The foregoing description of the present invention has been presented for illustrative purposes, and it is apparent to a person having ordinary skill in the art that various modifications and variations may be made without departing from the essential features of the invention. Therefore, it should be understood that the forgoing embodiments are by way of example only, and are not intended to limit the scope of the technical idea of the invention. The scope of protection of the invention shall be construed in accordance with the following claims, and all technical ideas within the scope of the equivalents shall be construed to be included in the scope of the invention.

Accordingly, the above-described embodiments are provided to fully inform the scope of invention to a person having ordinary skill in the art, and thus it should be understood to be exemplary and non-limiting in all respects, and the invention is defined only by the scope of the claims.

### ACKNOWLEDGMENTS

This work was supported by the Korea Institute of Energy Technology Evaluation and Planning(KETEP) and the Ministry of Trade, Industry & Energy(MOTIE) of the Republic of Korea (No. 20213030030210).

### DESCRIPTION OF REFERENCE NUMERALS

100: bus
200: trailer
210: safety shield
FD: front door, vertical sliding door for replacing and inspecting fuel cell modules and parts installed inside the trailer
SD: side door, swivel-opening door for replacing and inspecting fuel cell modules and parts installed inside the trailer
ReD: rear door, vertical sliding door for replacing and inspecting fuel cell modules and parts installed inside the trailer
RoD: roof door, removable type, with a removable door for replacing the hydrogen tank assembly

What is claimed is:

1. A rear trailer docking type trailer fuel cell system, comprising:
a fuel cell package;
a trailer for mounting the fuel cell package; and
a trailer mounting unit for docking the trailer with the fuel cell package to a vehicle.

2. The rear trailer docking type trailer fuel cell system of claim 1, wherein the fuel cell package comprises a hydrogen tank to be configured as a stand-alone system.

3. The rear trailer docking type trailer fuel cell system of claim 1, wherein the trailer is capable of independent operation in a trailer docking type, and provides a module fuel cell system comprising a front door, a side door, a rear door, and a roof door to facilitate repair and replacement of parts.
